(19) United States
(12) Patent Application Publication
(10) Pub. No.: US 2002/0199122 A1
(43) Pub. Date: Dec. 26, 2002

(54) Computer security vulnerability analysis methodology

(76) Inventors: Lauren B. Davis, Reisterstown, MD (US); Hui Men, Rockville, MD (US)

Correspondence Address: Benjamin Y. Roca, Office of Patent Counsel, The Johns Hopkins University, Applied Physics Laboratory, 11100 Johns Hopkins Road, Laurel, MD, 20723-6099, US

(21) Appl. No.: 10/177,455

(22) Filed: Jun. 21, 2002

Related U.S. Application Data
(60) Provisional application No. 60/300,178, filed on Jun. 22, 2001.
(60) Provisional application No. 60/300,175, filed on Jun. 22, 2001.

(51) Int. Cl. G06F 11/30

(52) U.S. Cl. 713/201

(57) ABSTRACT

A methodology of evaluating computer security vulnerabilities in computer products for domain-specific characteristics, statistical trends, and innovative mitigation strategies is presented. The methodology can be programmed into a computer system. Raw security vulnerability data pertaining to a computer product to be analyzed is culled from a pool of trusted resources. Redundant data is combined into separate mutually exclusive records and parsed using a hierarchical taxonomy of security characteristics and security analysis terms. The taxonomy serves to harmonize disparate terminology through the use of canonical terms that equate multiple synonymous terms with the canonical term. The taxonomy also serves to categorize the vulnerability according to a hierarchy of categories and sub-categories so that it may be logically processed and presented to an analyst. Data pertaining to a computer product can be analyzed independently, in composite classes of products, or compared against data that has been similarly obtained and processed for peer products.

### CROSS-REFERENCE TO RELATED APPLICATIONS

This application claims the benefit of U.S. Provisional Application No. 60/300,178, filed on Jun. 22, 2001, which is hereby incorporated by reference in its entirety.

### STATEMENT OF GOVERNMENTAL INTEREST

This invention was made with Government support under contract no. N00024-98-D-8124 with the Department of Defense, Washington, DC. The Government has certain rights in the invention.

### BACKGROUND OF THE INVENTION

Security vulnerabilities in computer products pose a significant concern to computer system users on all levels. The ability to ensure the availability, integrity, and confidentiality of computer systems or at least reduce any damage that may occur as a result of a security vulnerability is of great importance to those responsible for the security of such computer systems.

Having up-to-date data pertaining to security vulnerabilities of computer products that is presented in an orderly format is essential to creating and operating a computer system resistant to security breaches. Unfortunately, this data is scattered about multiple sources that are not standardized or uniform with respect to terminology, format, or completeness. There currently exists no viable means of organizing reliable security vulnerability data that is scattered about multiple sources into a concise usable format for evaluation of security analysis characteristics and trends.

### SUMMARY

The present invention comprises a methodology for analysis of computer security vulnerabilities for individual computer products, or for classes of computer products such as operating systems, application suites, protocols or information assurance products. The methodology can be programmed into a computer system. Raw security vulnerability data pertaining to a computer product to be analyzed is culled from a pool of trusted resources. Redundant data is combined to create mutually exclusive vulnerability records and applied to a hierarchical taxonomy of security characteristics and security analysis terms. The taxonomy serves to harmonize disparate terminology through the use of canonical terms that equate multiple synonymous terms with the canonical term. The taxonomy also serves to classify or describe the vulnerability according to a hierarchy of categories and sub-categories so that it may be logically processed and presented to an analyst. Data pertaining to a given computer product or class of products may be analyzed as an independent entity or compared against data that has been similarly obtained and processed for peer products in another related class (such as Unix versus Windows operating systems) or specific vendor product comparisons. The comparison provides a basis of evaluation for the given computer product.

### BRIEF DESCRIPTION OF THE DRAWINGS

FIG. 1 illustrates a hierarchical structure of a taxonomy of security analysis terms.

FIG. 2 illustrates an example of data in a taxonomy of security analysis terms.

FIG. 3 illustrates a flowchart of the analysis of security vulnerabilities for a computer product.

FIG. 4 illustrates a vulnerability trend line comparing a computer product against several peer products.

FIG. 5a illustrates an error analysis for a conglomerate set of operating systems.

FIG. 5b illustrates an error analysis for a peer conglomerate set of operating systems.

FIG. 6a illustrates a damage analysis for a conglomerate set of operating systems.

FIG. 6b illustrates a damage analysis for a peer conglomerate set of operating systems.

FIG. 7a illustrates a system compromise analysis for a conglomerate set of operating systems.

FIG. 7b illustrates a system compromise analysis for a peer conglomerate set of operating systems.

FIG. 8 illustrates a vulnerability analysis of one type of vulnerability characteristic for a computer product versus a peer product.

FIG. 9 illustrates an alternative vulnerability analysis of a different type of vulnerability characteristic for a computer product versus a peer product.

### DETAILED DESCRIPTION

The present invention provides an implementable methodology that can be used to evaluate computer security vulnerabilities of individual computer products, conglomerate sets of computer products, or comparisons of computer products or sets thereof. The term computer product as it relates to the present invention includes computer hardware, computer software, computer firmware, operating systems, protocols, applications, network equipment (e.g., routers, firewalls), and computer peripheral products.

The present invention relies on two pools of data. The first is a collection of security bulletins from reliable sources with respect to commercial computer products. These sources include, inter alia, Computer Emergency Response Team (CERT)-type organizations such as: Carnegie Mellon University's CERT-CC; the Australian Computer Emergency Response Team (AusCERT); the U.S. Department of Energy Computer Incident Advisory Capability (CIAC) Information Bulletins; Internet Security Systems (ISS) X-Force Alerts; Bugtraq Vulnerability Advisories; and specific Vendor Bulletins (e.g., Microsoft, HP, Red Hat, Sun Microsystems, etc . . . ). Other security vulnerability data sources may be used at the discretion of an analyst.

The security vulnerability bulletins are periodically mined for security analysis terms. An example of a vulnerability description that appeared in a June 2000 security bulletin is listed below.

ufsrestore Buffer Overflow Vulnerability: Jun. 14, 2000—Boundary Condition Error in ufsrestore affecting Sun Solaris 8.0, Solaris 7.0, and Solaris 2.6, resulting in a local root compromise. The method of operation of exploitation is via overly long strncat arguments. The setuid properties act as an enabler for exploitation. The recommended corrective actions are to disable the setuid bit, copy utilities to a floppy disk and delete them from the system, and await a forthcoming patch. The risk assigned to this vulnerability is high. Active attacks of this vulnerability were reported at the time the bulletins were issued.

The second pool of data used in connection with the present invention is a taxonomy of security analysis terms (TSAT), representing security analysis terms that are deemed relevant for the vulnerability analysis, and organized in a hierarchical fashion. Any security analysis terms in the taxonomy that appear in a bulletin are extracted from the bulletin and entered into a spreadsheet or database. The taxonomy is an evolving analysis tool that provides a framework for performing a security vulnerability analysis.

Combining redundant or overlapping security bulletins creates a mutually exclusive set of vulnerability analysis data. Overlapping security bulletins are not necessarily duplicates, however. They may contain different types of information, but the vulnerability covered may be the same. Consequently, all the information in all the bulletins that pertain to a single vulnerability are included in the resultant spreadsheet or database, but not necessarily as separate entries. Furthermore, multiple bulletins may address a single vulnerability due to independent reporting by numerous organizations and vendors. Or, additional information became available, or further exploits of the vulnerability were detected.

The taxonomy represents a hierarchical collection of vulnerability characteristic categories and specific vulnerability characteristics within each category, used to describe and classify computer security vulnerabilities. Specific keyword terms are derived from a comprehensive analysis of the reliable sources mentioned above including computer security bulletins, articles, and other security documents. The taxonomy hierarchy is an organization of nested taxonomy categories. The taxonomy is both exhaustive and mutually exclusive.

The vulnerability characteristics categorized by the taxonomy include: vulnerability error, potential damage resulting from exploitation, severity, enablers, methods of operation, and corrective actions. Taxonomy categories are grouped entities that may contain sub-categories or dictionary entries but not both. Primary categories comprise the base category level in a taxonomy hierarchy. Primary categories may have sub-categories if the primary category is broad enough to be logically partitioned. Similarly, sub-categories may be further decomposed if there exists a logical reason for doing so. Once the lowest level category or sub-category is reached, it is associated with one or more canonical terms.

A canonical term may be characterized as a standardized description that maps multiple security analysis terms back to a single uniform term. The concept of a canonical term simplifies the analysis process by grouping various different terms or phrases that refer to the same vulnerability characteristic. The use of canonical terms provides a mechanism for reconciling the language employed by different people or organizations when attempting to describe a security vulnerability characteristic. For instance, one bulletin may have labeled potential damage as “Account Break-in” in a description of the computer product vulnerability while another bulletin has labeled the same type of damage as “Account Compromise” in a separate description of the same or similar computer product vulnerability.

The lowest level in the taxonomy hierarchy is the entry. An entry can comprise words, phrases, non-fixed strings, or full-word strings describing a security analysis term. Every entry is associated with a canonical term. The first entry associated with a canonical term is, by definition, the canonical term.

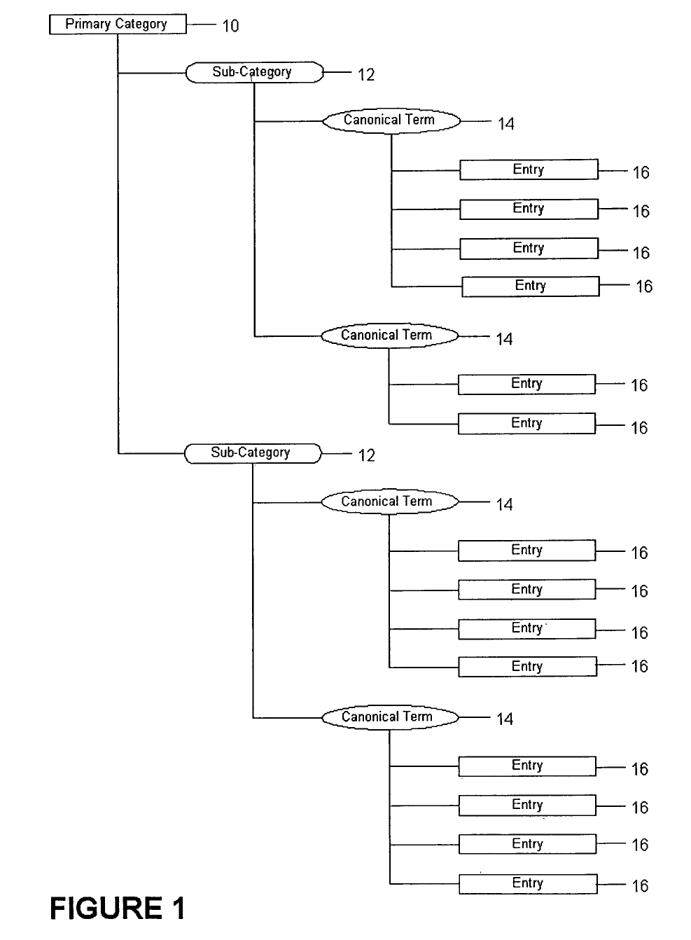

FIG. 1 illustrates a hierarchical structure of a taxonomy. At the root or base level there are primary categories 10. Sub-categories 12 may exist under the primary categories 10. Once the hierarchy reaches its lowest categorical level, one or more canonical terms 14 are assigned to the sub-category 12. The canonical terms are then associated with a list of dictionary entries 16. Each entry 16 is analogous to the other entries 16 for that category and all of the entries are mapped back to their canonical term 14.

It is possible that the primary category 10 need not be partitioned into sub-categories 12 in which case one or more canonical terms 14 are directly associated with a primary category 10. In addition, a sub-category 12 may be further divided into other sub-categories if there is a logical reason for doing so. Moreover, the number of entries 16 for a canonical term 14 can vary depending on the diversity of the language used to describe a security analysis term. Thus, the hierarchy illustrated in FIG. 1 is merely an illustration and not intended to limit the present invention.

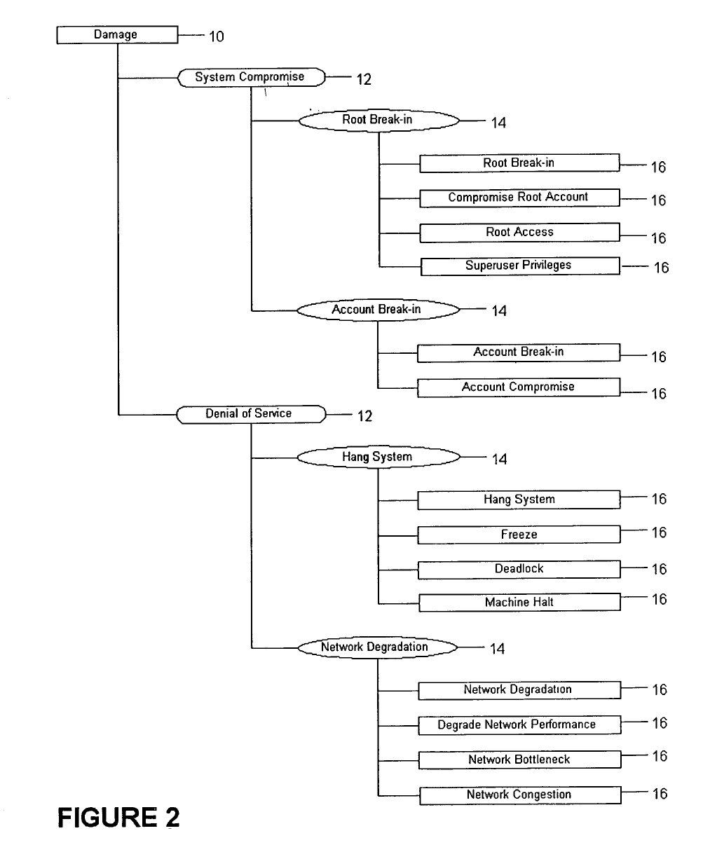

FIG. 2 provides sample data for a taxonomy of security analysis terms. FIG. 2 has been arbitrarily structured to “read on” the hierarchy presented in FIG. 1. The primary category 10 is labeled “Damage”. Under the damage category are two sub-categories 12; System Compromise, and Denial of Service. The System Compromise sub-category 12 is associated with two canonical terms 14 labeled “Root Break-in” and “Account Break-in”. The Root Break-in canonical term encompasses four entries 16 in this case. These include Root Break-in, Compromise Root Account, Root Access, and Superuser Privileges. The Account Break-in canonical term encompasses two entries 16 which are Account Break-in and Account Compromise.

Similarly, the Denial of Service sub-category 12 is associated with two canonical terms 14 labeled “Hang System” and “Network Degradation”. The Hang System canonical term encompasses four entries 16 in this case. These include Hang System, Freeze, Deadlock, and Machine Halt. The Network Degradation canonical term also encompasses four entries 16. These include Network Degradation, Degrade Network Performance, Network Bottleneck, and Network Congestion.

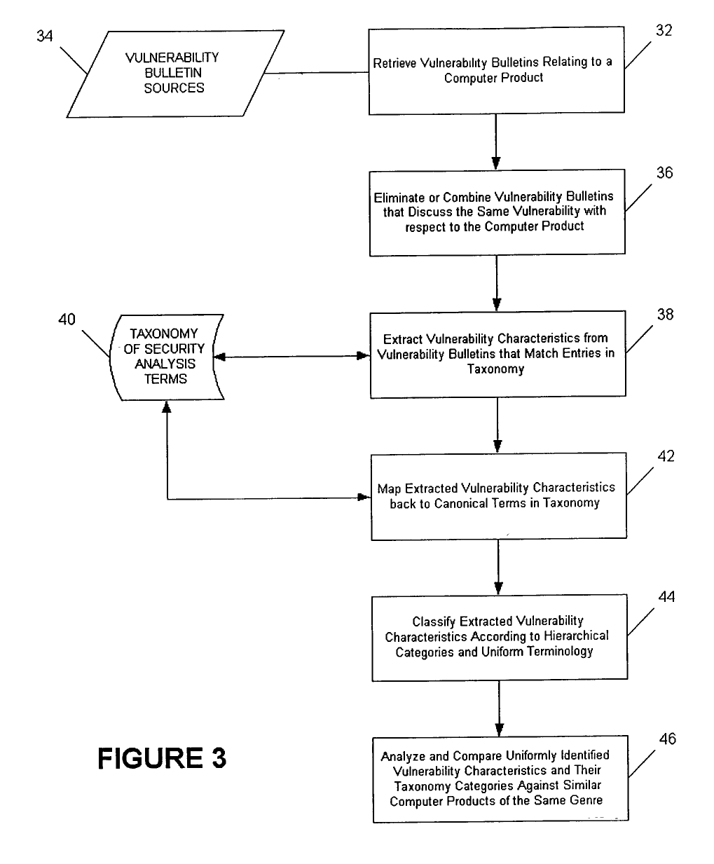

FIG. 3 illustrates the methodology used to evaluate computer security vulnerabilities. Security vulnerability bulletins relating to a computer product are retrieved 32 from the pool of trusted sources 34. Once the relevant security bulletins have been obtained, they are initially reviewed to remove any duplicates 36. That is, multiple bulletins addressing the same vulnerability characteristic are combined into a single bulletin. Once a mutually exclusive set of vulnerability bulletins pertaining to the computer product has been identified, vulnerability characteristics are extracted from the bulletins 38 by applying the taxonomy 40. The extracted vulnerability characteristic terms are mapped back to a canonical term in the taxonomy 42. The mapped terms are then classified according to their hierarchical categories and uniform terminology 44 and entered into a spreadsheet or database. Lastly, a statistical and trend analysis is performed on the terms based upon where the extracted terms fall in the hierarchical categories 46.

The statistical and trend analysis of the data obtained from the taxonomy comprises the quantification of characteristics of known vulnerabilities. Examples include: a chronology illustrating the frequency of vulnerability reports, the elapsed time between the initial public announcement of a vulnerability and when a vendor solution is issued, the risk of vulnerabilities to exploitation, the types of errors causing the vulnerabilities, the frequency of occurrence as a function of the platform, the scope of damage that can result from exploitation of such vulnerabilities, the actual methods employed to exploit these errors, any corrective actions to remedy the situation, and future projections based on trends documented in available data.

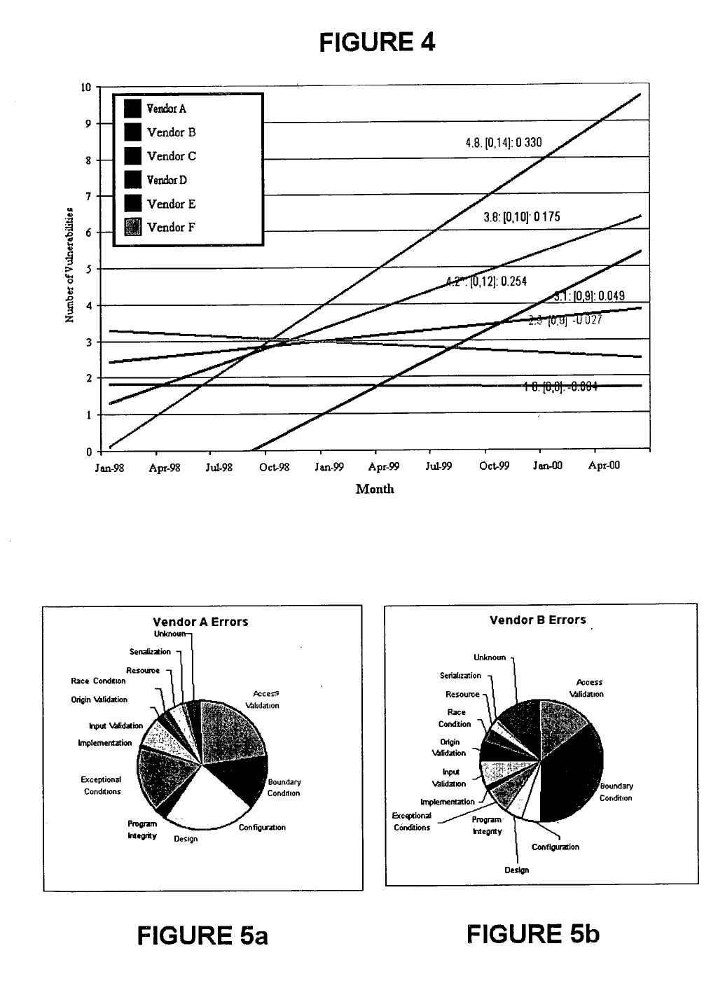

Results of a statistical analysis that can be performed according to the present invention are presented in FIGS. 4-9. These figures illustrate a hypothetical analysis of data for a conglomerate set of operating systems and compares the results against other conglomerate sets of operating systems. The data presented by these examples is fictitious. The purpose of the figures is to illustrate the kind of analysis that can be performed by the methodology of the present invention. The figures comprise charts and diagrams that allow an analyst to evaluate the security vulnerability data for a given computer product, or conglomerate sets of products. The results are presented in terms of a comparison with a peer product or set thereof to help provide a basis for evaluation, but may also be used independently (i.e. noticing that all root break-ins from buffer overflows involve installing a program to always run as root). The example described herein uses only one peer product for comparison purposes. The number of peer products used for an analysis can vary depending on the needs of the analysts and the number of peer products that exist.

FIG. 4 illustrates vulnerability trend lines for the type of computer product of interest, an operating system. In this example, six operating systems are listed in the analysis. The purpose of this graph is to show a chronology of vulnerability reports for each product. The number strings {w:[x,y]:z} on the graph translate according to the chart:

w: average number of new vulnerabilities reported per month

x: lowest number of new vulnerabilities in any month

y: highest number of new vulnerabilities in any month

z: slope of trend line

Operating systems having steeper slopes indicate more new reported vulnerabilities each subsequent month. This commonly occurs when a product has a rapidly growing user base and or rapidly changing functionality. Products implemented long enough for stability often show a flatter trendline.

Whatever the reason, the illustration in FIG. 4 provides the analyst with a snapshot of the comparative number of vulnerabilities associated with similar products over time. FIG. 4 presents vulnerability data analysis in terms of all vulnerabilities, regardless of the type of vulnerability error.

FIGS. 5a and 5b present a breakdown of the vulnerability data according to the type of vulnerability error for conglomerate sets of two types of operating systems in the hypothetical example. The data is presented in the form of a pie chart in this example. A cursory examination reveals that Vendor A is susceptible to many more “exceptional condition” errors than Vendor B but produces significantly less “boundary condition” errors than Vendor B. This type of data may be important to an analyst evaluating computer products in regard to the mitigation strategies that might apply to specific types of vulnerability errors.

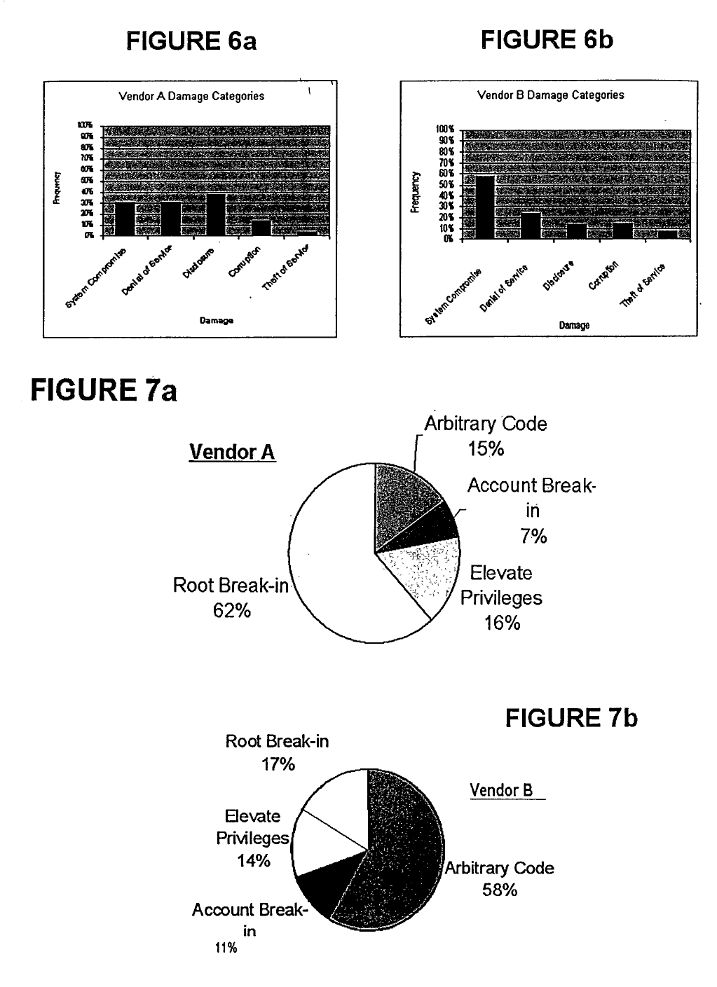

FIGS. 6a and 6b provide a detailed analysis based upon the damage categories of the taxonomy. FIG. 6a plots the percent of vulnerabilities resulting in a particular type of damage category for Vendor A's product. FIG. 6b presents the exact same data for Vendor B's product. The two graphs could have been merged into a single chart if desired. System compromise is the most egregious type of damage. It becomes clear that the percent of vulnerabilities that are severely damaging is greater for Vendor B (approximately 60%) than for Vendor A (approximately 30%).

FIGS. 7a and 7b break down the analysis even further by focusing on the subcategories of system compromise specifically. These pie charts list the canonical terms associated with the sub-category of system compromise. FIG. 7a (Vendor A) has a significantly higher occurrence of root break-ins than FIG. 7b (Vendor B). Again, this could be critical information because root break-ins are deemed very serious because of the potential widespread damage that can occur as a result.

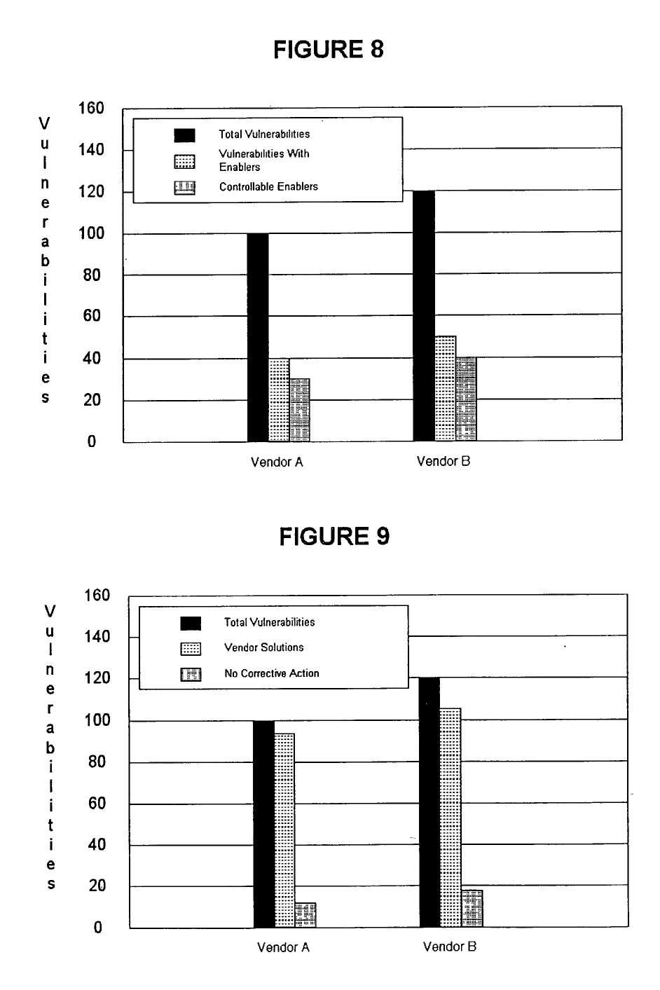

FIG. 8 charts a comparison of Vendor A vs. Vendor B with respect to total vulnerabilities, enablers, and controllable enablers. An enabler is a condition that can affect a particular vulnerability. Some vulnerabilities may require the presence of an enabler to fully exploit the vulnerability. In such cases the vulnerability may be controllable by controlling the enabler as a form of corrective action. FIG. 8 decomposes total vulnerabilities into vulnerabilities that require enablers and within that subset, enablers that can be controlled. The specific data illustrated in FIG. 8 reveals that approximately ⅓of the total vulnerabilities for Vendor A and Vendor B require enablers. Moreover, about 80% of the vulnerabilities that have enablers have controllable enablers for the operating system of both vendors.

FIG. 9 illustrates the number of different types of vendor solutions attributable to the total number of vulnerabilities and the number of vulnerabilities having no corrective action as yet. This data provides an analyst with a sense of whether the vulnerability can be worked around or if it still poses a threat.

The above charts, graphs, and figures for the fictitious example represent data culled from reliable sources and applied to the hierarchical taxonomy. The breadth and scope of the statistical analysis provides analysts with a wealth of information to be used in considering the types of mitigation strategies to employ for specific products or classes of products, and may be used in evaluation of specific products for system integration.

To evaluate a computer product against peer products it is necessary to have analyzed the peer products in the same manner as the computer product in question. It is also recommended that the steps that involve retrieving and processing vulnerability characteristics from security bulletins be updated frequently. This ensures that a product is being evaluated with the most recent data available.

The data from a previous analysis can be archived for future use so that future analysis efforts need not be completely duplicated, merely updated. Archived computer product analyses may need to be updated if they are deemed out-of-date. Updating an analysis entails retrieving security vulnerability data from the present back to the last known date that data was gathered for the computer product in question.

In addition, from time to time it may be necessary to update the taxonomy to accommodate new categories or newly discovered vulnerability characteristics. New entries may need to be incorporated into the taxonomy and associated with a canonical term. New canonical terms may also need to be created if a new category or sub-category is introduced. Thus, the taxonomy is an evolving tool.

It is to be understood that the present invention illustrated herein is readily implementable by those of ordinary skill in the art as a computer program product having a medium with computer program(s) embodied thereon. The computer program product is capable of being loaded and executed on the appropriate computer processing device(s) in order to carry out the method or process steps described. Appropriate computer program code in combination with hardware implements many of the elements of the present invention. This computer code is typically stored on removable storage media. This removable storage media includes, but is not limited to, a diskette, standard CD, pocket CD, zip disk, or mini zip disk. Additionally, the computer program code can be transferred to the appropriate hardware over some type of data network.

The present invention has been described, in part, with reference to flowcharts or logic flow diagrams. It will be understood that each block of the flowchart diagrams or logic flow diagrams, and combinations of blocks in the flowchart diagrams or logic flow diagrams, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks or logic flow diagrams.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart blocks or logic flow diagrams. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart blocks or logic flow diagrams. Accordingly, block(s) of flowchart diagrams and/or logic flow diagrams support combinations of means for performing the specified functions, combinations of steps for performing the specified functions and program instruction means for performing the specified functions. It will also be understood that each block of flowchart diagrams and/or logic flow diagrams, and combinations of blocks in flowchart diagrams and/or logic flow diagrams can be implemented by special purpose hardware-based computer systems that perform the specified functions or steps, or combinations of special purpose hardware and computer instructions.

In the following claims, any means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A computer for analyzing security vulnerabilities in a computer product, comprising:
a memory containing:
a retrieval computer program that retrieves computer security vulnerability data pertaining to the computer product being analyzed;
a extraction computer program that extracts vulnerability terms from the retrieved computer security vulnerability data;
a classification computer program that classifies the extracted vulnerability terms according to a hierarchical taxonomy of vulnerability characteristics; and
an analysis computer program that analyzes the classified vulnerability terms and characteristics for the computer product being analyzed, the analysis being based on the taxonomy hierarchy associated with the vulnerability terms; and
a processor for executing the retrieval computer program, extraction computer program, classification computer program, and analysis computer program.

2. The computer of claim 1 wherein the extraction computer program eliminates any redundant data retrieved by the retrieval computer program to create mutually exclusive vulnerability data pertaining to the computer product being analyzed.

3. The computer of claim 2 wherein the classification program associates each extracted vulnerability term for the computer product being analyzed to a canonical term that is linked with a vulnerability characteristic appearing in the hierarchical taxonomy of vulnerability characteristics.

4. The computer of claim 3 wherein the analysis computer program:
performs a statistical analysis on the classified vulnerability characteristics for the computer product being analyzed; and
organizes the statistical analysis of the vulnerability characteristics for the computer product being analyzed.

5. The computer of claim 4 wherein the analysis computer program further outputs the organized statistical analysis in a human readable format.

6. A method of analyzing security vulnerabilities in a computer product, comprising:
retrieving computer security vulnerability data pertaining to the computer product being analyzed;
extracting vulnerability terms from the retrieved computer security vulnerability data;
classifying the extracted vulnerability terms according to a hierarchical taxonomy of vulnerability characteristics; and
analyzing the classified vulnerability terms and characteristics for the computer product being analyzed, the analysis being based on the taxonomy categories associated with the vulnerability terms.

7. The method of claim 6 wherein the extracting step further comprises eliminating any redundant data retrieved during the retrieving step to create mutually exclusive vulnerability data pertaining to the computer product being analyzed.

8. The method of claim 7 wherein the classifying step further comprises associating each extracted vulnerability term for the computer product being analyzed to a canonical term that is linked with a vulnerability characteristic appearing in the hierarchical taxonomy of vulnerability characteristics.

9. The method of claim 8 wherein the analyzing step further comprises:
performing a statistical analysis on the classified vulnerability characteristics for the computer product being analyzed; and
organizing the statistical analysis of the vulnerability characteristics for the computer product being analyzed.

10. The method of claim 9 wherein the analyzing step further comprises outputting the organized statistical analysis in a human readable format.

11. A computer-readable medium whose contents cause a computer system to analyze security vulnerabilities in a computer product, the computer system having a retrieval computer program, an extraction computer program, a classification computer program, and an analysis computer program with functions for invocation, by performing the steps of:
retrieving computer security vulnerability data pertaining to the computer product being analyzed;
extracting vulnerability terms from the retrieved computer security vulnerability data;
classifying the extracted vulnerability terms according to a hierarchical taxonomy of vulnerability characteristics; and
analyzing the classified vulnerability terms and characteristics for the computer product being analyzed, the analysis being based on the taxonomy categories associated with the vulnerability terms.

12. The computer-readable medium of claim 11 wherein the extracting step further comprises eliminating any redundant data retrieved during the retrieving step to create mutually exclusive vulnerability data pertaining to the computer product being analyzed.

13. The computer-readable medium of claim 12 wherein the classifying step further comprises associating each extracted vulnerability term for the computer product being analyzed to a canonical term that is linked with a vulnerability characteristic appearing in the hierarchical taxonomy of vulnerability characteristics.

14. The computer-readable medium of claim 13 wherein the analyzing step further comprises:
performing a statistical analysis on the classified vulnerability characteristics for the computer product being analyzed; and
organizing the statistical analysis of the vulnerability characteristics for the computer product being analyzed.

15. The computer-readable medium of claim 14 wherein the analyzing step further comprises outputting the organized statistical analysis in a human readable format.

16. A computer system for analyzing security vulnerabilities in a computer product, comprising:
means for retrieving computer security vulnerability data pertaining to the computer product being analyzed;
means for extracting vulnerability terms from the retrieved computer security vulnerability data;
means for classifying the extracted vulnerability terms according to a hierarchical taxonomy of vulnerability characteristics; and
means for analyzing the classified vulnerability terms and characteristics for the computer product being analyzed, the analysis being based on the taxonomy categories associated with the vulnerability terms.

17. The computer system of claim 16 wherein the means for extracting further comprises means for eliminating any redundant data retrieved by the means for retrieving to create mutually exclusive vulnerability data pertaining to the computer product being analyzed.

18. The computer system of claim 17 wherein the means for classifying further comprises means for associating each extracted vulnerability term for the computer product being analyzed to a canonical term that is linked with a vulnerability characteristic appearing in the hierarchical taxonomy of vulnerability characteristics.

19. The computer system of claim 18 wherein the means for analyzing further comprises:
means for performing a statistical analysis on the classified vulnerability characteristics for the computer product being analyzed; and
means for organizing the statistical analysis of the vulnerability characteristics for the computer product being analyzed.

20. The computer system of claim 19 wherein the means for analyzing further comprises means for outputting the organized statistical analysis in a human readable format.
